(19) United States
(12) Patent Application Publication
(10) Pub. No.: US 2025/0002812 A1
(43) Pub. Date: Jan. 2, 2025

(54) WATER-SOLUBLE UNIT DOSE ARTICLE COMPRISING A CONCENTRATED DETERGENT COMPOSITION

(71) Applicant: The Procter & Gamble Company, Cincinnati, OH (US)

(72) Inventors: Kevin BEKAERT, Wemmel (BE); Karel Jozef Maria DEPOOT, Anzegem-Vichte (BE); Wouter WALRAVENS, Humbeek (BE)

(21) Appl. No.: 18/752,860

(22) Filed: Jun. 25, 2024

(30) Foreign Application Priority Data
Jun. 28, 2023 (EP) 23181964.0
Feb. 15, 2024 (EP) 24157862.4
Feb. 15, 2024 (EP) 24157863.2
Feb. 15, 2024 (EP) 24157867.3

(51) Int. Cl. C11D 1/83; C11D 1/22; C11D 1/29; C11D 1/72; C11D 3/20; C11D 3/386; C11D 3/43; C11D 17/04

(52) U.S. Cl. CPC C11D 1/83; C11D 3/2079; C11D 3/38618; C11D 3/38636; C11D 3/43; C11D 17/045; C11D 1/22; C11D 1/29; C11D 1/72

(57) ABSTRACT

A water-soluble unit dose article comprising a concentrated laundry detergent composition, wherein the laundry detergent composition comprises from 50% to 65% by weight of the composition of non-soap surfactant comprising anionic non-soap surfactant and nonionic surfactant; wherein the nonionic surfactant comprises alcohol ethoxylate surfactant and the weight ratio of non-soap anionic surfactant to non-ionic surfactant is less than or equal to 1.5:1; from 5% to 20% by weight of the composition of organic solvent; and from 5% to 25% by weight of the composition of water.

### FIELD OF THE INVENTION

Water-soluble unit dose article comprising a concentrated detergent composition.

### BACKGROUND OF THE INVENTION

Water-soluble unit dose detergent articles are liked by consumers as they are convenient and efficient to use. Such water-soluble unit dose articles comprise detergent compositions enveloped by a water-soluble film. When the water-soluble unit dose detergent article is added to water, the film dissolves/disintegrates releasing the detergent into the surrounding water to create a cleaning liquor.

There are a lot of constrains when formulating detergent compositions to be housed within the water-soluble unit dose article, in particular when the composition is in liquid form. The detergent composition should be stable, have the right viscosity to allow for easy manufacture and easy dissolution in use and the composition should be compatible with the water-soluble film. Usually, the detergent composition comprises aqueous and/or non-aqueous solvents to help with the above requirements. These solvents can help to prevent physical phase instability, to control viscosity to enable dosebility during manufacture as well as good dissolution profile upon use, as well as to secure proper water-soluble film plasticization to prevent premature rupture. A water-soluble film of too low level of plasticisation becomes brittle upon ageing and as such becomes susceptible to premature rupture. Solvents might not contribute much to the product performance upon use, such as cleaning, whiteness, freshness or fabric or hard surface care, and therefore there is a desire to reduce the amount of solvent in the detergent composition. However, just reducing the level of solvent will bring physical and chemical instabilities to the composition and incompatibility with the water-soluble film.

Therefore, there is a need to provide detergent compositions more highly concentrated in active ingredients and comprising lower amounts of solvents. Such compositions have benefits including reduced costs and reducing overall carbon footprint of the detergent compositions.

### SUMMARY OF THE INVENTION

A water-soluble unit dose article comprising a concentrated detergent composition, wherein the detergent composition comprises from 50% to 65% by weight of the composition of a non-soap surfactant system comprising anionic non-soap surfactant and nonionic surfactant; wherein the nonionic surfactant comprises alcohol ethoxylate surfactant and the weight ratio of non-soap anionic surfactant to non-ionic surfactant is less than or equal to 1.5:1; from 5% to 20% by weight of the composition of organic solvent; and from 5% to 25% by weight of the composition of water.

### BRIEF DESCRIPTION OF THE DRAWINGS

FIG. 1 is a water-soluble unit dose article according to the present invention.

### DETAILED DESCRIPTION OF THE INVENTION

### Water-Soluble Unit Dose Article

The present invention discloses a water-soluble unit dose article comprising a water-soluble film and a detergent composition, preferably a laundry detergent composition. The water-soluble film and the laundry detergent composition are described in more detail below. The laundry detergent composition preferably is a liquid laundry detergent composition.

The water-soluble unit dose detergent article comprises the water-soluble film shaped such that the unit-dose article comprises at least one internal compartment surrounded by the water-soluble film. The unit dose article may comprise a first water-soluble film and a second water-soluble film sealed to one another such to define the internal compartment. The water-soluble unit dose article is constructed such that the detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the detergent composition. During manufacture, a first water-soluble film may be shaped to comprise an open compartment into which the detergent composition is added. A second water-soluble film is then laid over the first film in such an orientation as to close the opening of the compartment. The first and second films are then sealed together along a seal region.

The unit dose article may comprise more than one compartment, even at least two compartments, or even at least three compartments, or even at least four compartments. The compartments may be arranged in superposed orientation, i.e. one positioned on top of the other. In such an orientation the unit dose article will comprise at least three films, top, one or more middle, and bottom. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment but does not completely enclose the second compartment. Alternatively, one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side. The unit dose article may comprise at least four compartments, three of the compartments may be smaller than the fourth compartment, and preferably the smaller compartments are superposed on the larger compartment. The superposed compartments preferably are orientated side-by-side.

In a multi-compartment orientation, the detergent composition according to the present invention may be comprised in at least one of the compartments. It may for example be comprised in just one compartment, or may be comprised in two compartments, or even in three compartments, or even in four compartments.

Each compartment may comprise the same or different compositions. The different compositions could all be in the same form, or they may be in different forms.

The water-soluble unit dose article may comprise at least two internal compartments, wherein the laundry detergent composition is comprised in at least one of the compartments, preferably wherein the unit dose article comprises at least three compartments, wherein the detergent composition is comprised in at least one of the compartments.

The water-soluble unit dose article may comprise from 1 gram up to 60 gram, preferably from 5 gram up to 50 gram, more preferably from 10 gram up to 40 gram, most preferably from 12 gram up to 25 gram alternatively from 30 gram to 40 gram of the laundry detergent composition. The water-soluble unit dose article may comprise from 1 ml up to 60 ml, preferably from 5 ml up to 50 ml, more preferably from 10 ml up to 40 ml, most preferably from 12 ml up to 25 ml, alternatively from 30 ml to 40 ml of the liquid laundry detergent composition.

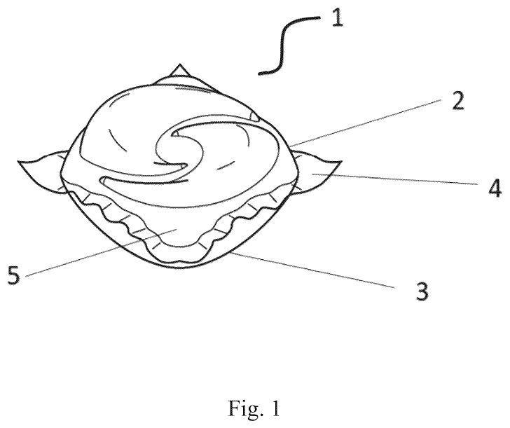

FIG. 1 discloses a water-soluble unit dose article (1) according to the present invention. The water-soluble unit dose article (1) comprises a first water-soluble film (2) and a second water-soluble film (3) which are sealed together at a seal region (4). The laundry detergent composition (5) is comprised within the water-soluble soluble unit dose article (1).

### Water-Soluble Film

The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:

5 grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Preferably, the water-soluble film comprises polyvinylalcohol polymer, preferably wherein the polyvinylalcohol polymer comprises polyvinyl alcohol homopolymer or polyvinyl alcohol copolymer, or a mixture thereof, preferably a blend of polyvinylalcohol homopolymers and/or polyvinylalcohol copolymers, preferably wherein the polyvinylalcohol copolymers are selected from sulphonated and carboxylated anionic polyvinylalcohol copolymers especially carboxylated anionic polyvinylalcohol copolymers, most preferably wherein the polyvinylalcohol polymer comprises a blend of a polyvinylalcohol homopolymer and a carboxylated anionic polyvinylalcohol copolymer or a blend of polyvinylalcohol homopolymers. Alternatively the water-soluble film may comprise a single polyvinylalcohol polymer, preferably a carboxylated anionic polyvinylalcohol copolymer.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

The film may be opaque, transparent or translucent. The film may comprise a printed area. The area of print may be achieved using standard techniques, such as flexographic printing or inkjet printing.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 ppm.

Preferably, the water-soluble film or water-soluble unit dose article or both are coated in a lubricating agent, preferably, wherein the lubricating agent is selected from talc, zinc oxide, silicas, siloxanes, zeolites, silicic acid, alumina, sodium sulphate, potassium sulphate, calcium carbonate, magnesium carbonate, sodium citrate, sodium tripolyphosphate, potassium citrate, potassium tripolyphosphate, calcium stearate, zinc stearate, magnesium stearate, starch, modified starches, clay, kaolin, gypsum, cyclodextrins or mixtures thereof.

Preferably, the water-soluble film, and each individual component thereof, independently comprises between 0 ppm and 20 ppm, preferably between 0 ppm and 15 ppm, more preferably between 0 ppm and 10 ppm, even more preferably between 0 ppm and 5 ppm, even more preferably between 0 ppm and 1 ppm, even more preferably between 0 ppb and 100 ppb, most preferably 0 ppb dioxane. Those skilled in the art will be aware of known methods and techniques to determine the dioxane level within water-soluble films and ingredients thereof.

### Detergent Composition

The water-soluble unit dose article comprises a detergent composition, the composition can be any cleaning or treatment composition such as a hard surface cleaning composition, an automatic dishwashing cleaning composition, a laundry composition, etc. Preferably the composition is a laundry detergent composition, more preferably the detergent composition is a liquid laundry detergent composition. The term ‘liquid laundry detergent composition’ refers to any laundry detergent composition comprising a liquid capable of wetting and treating a fabric, and includes, but is not limited to, liquids, gels, pastes, dispersions and the like. The liquid composition can include solids or gases in suitably subdivided form, but the liquid composition excludes forms which are non-fluid overall, such as tablets or granules.

The laundry detergent composition can be used in a fabric hand wash operation or may be used in an automatic machine fabric wash operation.

The laundry detergent composition comprises a non-soap surfactant system and an organic solvent system. The non-soap surfactant system and the organic solvent system are described in more detail below.

The laundry detergent composition comprises from 50% to 65%, preferably from 55% to 65%, more preferably from 55% to 65% by weight of the composition of a non-soap surfactant system. The non-soap surfactant system comprises a non-soap anionic surfactant and a nonionic surfactant system, wherein the nonionic surfactant comprises, preferably consists of, alcohol ethoxylate surfactant. The weight ratio of non-soap anionic surfactant to non-ionic surfactant is less than or equal to 1.5:1 preferably from 1.5:1 to 1:2, more preferably from 1.5:1 to 1:1. The non-soap anionic surfactant is preferably selected from neutralised linear alkylbenzene sulphonate, neutralised alkyl sulphate anionic surfactant selected from neutralised alkoxylated alkyl sulphate, neutralised non-alkoxylated alkyl sulphate, and mixtures thereof, or a mixture thereof. The non-soap anionic surfactant may comprise a mixture of neutralised linear alkylbenzene sulphonate and neutralised alkyl sulphate anionic surfactant. The weight ratio of neutralised linear alkylbenzene sulphonate to neutralised alkyl sulphate anionic surfactant may be from 1:2 to 9:1, or from 1:1 to 7:1, or from 1.5:1 to 6:1, or from 1.5:1 to 5:1. Alternatively the non-soap anionic surfactant system may be free of neutralised alkyl sulphate anionic surfactant. Alternatively the non-soap anionic surfactant system may consist of neutralized linear alkylbenzene sulphonate. For surfactant weight % or weight ratio calculation the weight of the neutralizing counterion in the case of anionic surfactants is not taken into account, e.g. for soap or non-soap anionic surfactants solely the weight of the surfactant anion is considered when calculating the soap or non-soap anionic surfactant weight % or soap or non-soap anionic surfactant to nonionic surfactant weight ratio.

Preferably, the non-soap anionic surfactant comprises linear alkylbenzene sulphonate. Preferably, the linear alkylbenzene sulphonate comprises C₁₀-C₁₆ alkyl benzene sulfonate, C₁₁-C₁₄ alkyl benzene sulphonate or a mixture thereof. Preferably, the alkylbenzene sulphonate is an amine neutralized alkylbenzene sulphonate, an alkali metal neutralized alkylbenzene sulphonate or a mixture thereof. The amine is preferably selected from monoethanolamine, triethanolamine, monoisopropanolamine or mixtures thereof. The alkali metal is preferably selected from sodium, potassium, magnesium or a mixture thereof. Preferably, the laundry detergent composition comprises between 5% and 45%, preferably between 7.5% and 40%, more preferably between 10% and 35% by weight of the laundry detergent composition of the linear alkylbenzene sulphonate.

The non-soap anionic surfactant may comprise an alkyl sulphate anionic surfactant wherein the alkyl sulphate anionic surfactant is selected from alkyl sulphate, an alkoxylated alkyl sulphate, or a mixture thereof. The alkyl sulphate anionic surfactant may be a primary or a secondary alkyl sulphate anionic surfactant, or a mixture thereof, preferably a primary alkyl sulphate anionic surfactant. Preferably, the alkoxylated alkyl sulphate comprises ethoxylated alkyl sulphate, propoxylated alkyl sulphate, a mixed ethoxylated/propoxylated alkyl sulphate, or a mixture thereof, more preferably an ethoxylated alkyl sulphate. Preferably, the ethoxylated alkyl sulphate has an average degree of ethoxylation of between 0.1 to 5, preferably between 0.5 and 3. Alternatively the alkyl sulphate anionic surfactant is free of alkoxylation. Preferably, the alkyl sulphate anionic surfactant has an average alkyl chain length of between 8 and 18, more preferably between 10 and 16, most preferably between 12 and 15. Preferably, the alkyl chain of the alkyl sulphate anionic surfactant is linear, branched or a mixture thereof. Preferably, the branched alkyl sulphate anionic surfactant is a branched primary alkyl sulphate, a branched secondary alkyl sulphate, or a mixture thereof, preferably a branched primary alkyl sulphate, wherein the branching preferably is in the 2-position, or alternatively might be present further down the alkyl chain, or could be multi-branched with branches spread over the alkyl chain. The weight average degree of branching of alkyl sulphate anionic surfactant may be from 0% to 100% preferably from 0% to 95%, more preferably from 0% to 60%, most preferably from 0% to 20%. Alternatively, the weight average degree of branching of alkyl sulphate anionic surfactant may be from 70% to 100%, preferably from 80% to 90%. Preferably, the alkyl chain is selected from naturally derived material, synthetically derived material or mixtures thereof. Preferably, the synthetically derived material comprises oxo-synthesized material, Ziegler-synthesized material, Guerbet-synthesized material, aldol condensation-synthesized material, Fischer-Tropsch—synthesized material, iso-alkyl synthesized material, or mixtures thereof, preferably oxo-synthesized material. Preferably, the laundry detergent composition comprises between 1% and 20%, preferably between 2% and 15%, more preferably between 4% and 10% by weight of the laundry detergent composition of the alkyl sulphate anionic surfactant. Alternatively, the composition is free of alkyl sulphate anionic surfactant. When alkyl ethoxy sulphate is present in the laundry detergent composition, the alkyl ethoxy sulphate starting material may have been treated to reduce the 1,4-dioxane content down to a level as low as less than 1 ppm per surfactant active. The skilled person will be aware of technical means to reduce the dioxane content in surfactant starting materials, including (multi-step) steam stripping, nano-filtration, or a combination thereof.

The laundry detergent composition comprises a non-ionic surfactant. The non-ionic surfactant comprises, preferably consists of, an ethoxylated alcohol non-ionic surfactant. Preferably, the laundry detergent composition comprises between 5% and 45%, or between 10% and 40%, or between 15% and 35% by weight of the laundry detergent composition of the ethoxylated alcohol non-ionic surfactant. The ethoxylated alcohol non-ionic surfactant may be a primary nonionic surfactant, a secondary nonionic surfactant, or a mixture thereof. Preferably the nonionic surfactant comprises a mixture of primary and secondary ethoxylated alcohol nonionic surfactant, more preferably wherein the primary and the secondary ethoxylated alcohol nonionic surfactant are present in a weight ratio of from 2:1 to 1:10, preferably from 1.5:1 to 1:7, more preferably from 1:1 to 1:5. The ethoxylated alcohol nonionic surfactant may be linear or may be branched. When branched, the branching may be at the 1-position, the 2-position or even further down the alkyl chain, wherein the carbon counting starts as of the carbon linked to the oxygen linker between the alkyl chain and the ethoxylation chain, The branching may be a single branching or a multi-branching. Most preferably the branching is a single branching at the 2-position. The branching preferably is an alkyl branching, more preferably a methyl, ethyl, propyl, butyl or pentyl branching, most preferably mixtures thereof. When linear the alkyl chain of the alcohol may have a natural distribution of C6 to C20 alkyl chains pending the source of the material. Alternatively, the linear alkyl alcohol may have been fractionated to magnify the C12 to C14 alkyl chain content. The ethoxylated alcohol non-ionic surfactant comprises an alkyl chain having an average of from 8 to 18 carbon atoms, preferably of from 10 to 16 more preferably 12 to 15 carbon atoms. The ethoxylated alcohol nonionic surfactant has an average degree of ethoxylation between 5 and 12, preferably between 6 and 10. The ethoxylated alcohol nonionic surfactant may have a broad range (BRE) or a narrow range (NRE) ethoxylation distribution. Narrow-range ethoxylates (NREs) are alcohol polyglycol ethers with a narrow homolog distribution and are known nonionic surfactants. Peaked alkoxylation and peaked ethoxylation are also often used to describe the process and materials produced. They can be produced industrially, for example, by the addition of ethylene oxide onto alcohols in the presence of suitable catalysts (layer compounds which have been calcined or hydrophobized with fatty acids). Examples of narrow range alkoxylation catalysts include many alkaline earth (Mg, Ca, Ba, Sr, etc.) derived catalysts, Lewis acid catalysts, such as Zirconium dodecanoxide sulfate, and certain boron halide catalysts, such as those described by Dupont and of the form MB(OR1)x(X)4-x or B(OR1)3/MX wherein R1 is a linear, branched, cyclic, or aromatic hydrocarbyl group, optionally substituted, having from 1 to 30 carbon atoms, M is Na+, K+, Li+, R2R3R4R5N+, or R2R3R4R5P+, where R2, R3, R4, and R5 independently are hydrocarbyl groups, and x is 1 to 3. This process can also be carried out on a variety of other hydrophobes and using different alkoxylating compounds (e.g., propylene oxide and butylene oxide) by modifying the catalyst properties. The narrow range ethoxylated alcohol non-ionic surfactant comprises at least 85% by weight of the total narrow range ethoxylate alcohol surfactant of alcohol ethoxylate nonionic surfactant molecules comprising a polyethoxy group comprising between 5 and 12, preferably between 6 and 10 ethoxy groups. The broad range ethoxylated alcohol non-ionic surfactant comprises polyethoxy groups, preferably, wherein between 15% and 45%, preferably between 25% and 40% by weight of the total broad range ethoxylated alcohol surfactant are ethoxylated alcohol nonionic surfactant molecules comprising a polyethoxy group comprising between 6 and 10 ethoxy groups, and wherein between 30% and 70%, preferably between 40% and 65% by weight of the total broad range ethoxylated alcohol surfactant are ethoxylated alcohol nonionic surfactant molecules comprise a polyethoxy group comprising between 5 and 12 ethoxy groups. The ethoxylated alcohol non-ionic surfactants may be derived from a natural alcohol source, a synthetic alcohol source, or a mixture thereof. Most suitable natural sources include palm kernel oil, coconut oil, or mixtures thereof, preferably palm kernel oil. When the ethoxylated alkyl alcohol non-ionic surfactant is derived from a synthetic alcohol source, the synthetic alcohol source preferably is made via an oxo process, a Ziegler process, a Guerbet process, an aldol condensation process, or a mixture thereof. The resulting alcohols can optionally but preferably be further fractionated to magnify the C12 to C15 content within the starting alcohol. Suitable examples of narrow range ethoxylated alcohol non-ionic surfactants are commercially available from the Nouryon company under the Berol or Ethylan tradenames, and from the Sasol company under the Novel tradename.

The laundry detergent composition may comprise a fatty acid, preferably a neutralized fatty acid soap. The fatty acid soap may be an amine neutralized fatty acid soap, wherein the amine is an alkanolamine more preferably selected from monoethanolamine, diethanolamine, triethanolamine, monoisopropanolamine or a mixture thereof, more preferably monoethanolamine. The laundry detergent composition may comprise between 1% and 20%, preferably between 3% and 17%, more preferably between 5% and 15% by weight of the laundry detergent composition of fatty acid, preferably a neutralized fatty acid soap.

The laundry detergent comprises between 5% and 25%, preferably between 7% and 20%, more preferably between 10% and 15% by weight of the detergent composition of water.

Preferably, the laundry detergent composition comprises between 5% and 20%, preferably between 10% and 17% by weight of the laundry detergent composition of a non-aqueous organic solvent, preferably wherein the non-aqueous organic solvent is selected from 1,2-propanediol, dipropylene glycol, tripropyleneglycol, glycerol, sorbitol, polyethylene glycol, ethoxylated glycerin or a mixture thereof. Preferably the non-aqueous organic solvent comprises 1,2-propanediol and glycerol, more preferably wherein the 1,2-propanediol and glycerol are in a weight ratio of from 1:3 to 12:1, preferably of from 1:2 to 9:1, more preferably from 1:1 to 6:1. The laundry composition preferably comprises less than 1% preferably less than 0.5% by weight of the composition of ethanol, most preferably the laundry composition is free of ethanol.

Preferably, the laundry detergent composition comprises an adjunct ingredient selected from the group comprising builders, perfumes, enzymes, citrate, bleach, bleach catalyst, dye, hueing dye, brightener, cleaning polymers including alkoxylated polyamines and polyethyleneimines, soil release polymer, fabric care polymers including cationic hydroxyethyl celluloses, cationic guar gums and cationic polyglucans, surfactant, solvent, dye transfer inhibitors, chelant, encapsulated perfume, polycarboxylates, structurant, pH trimming agents, anti-oxidants including Ralox 35, anti-foam agent, and mixtures thereof.

Preferably, the laundry detergent composition comprises a further enzyme selected from the group comprising hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, xyloglucanases, mannanases and amylases, nuclease or mixtures thereof, preferably a further enzyme selected from the group comprising proteases, amylase, cellulase, lipases, xyloglucanases, mannanases, nucleases, and mixtures thereof.

Preferably, the laundry detergent composition has a pH between 6 and 10, more preferably between 6.5 and 8.9, most preferably between 7 and 8, wherein the pH of the laundry detergent composition is measured as a 10% product concentration in demineralized water at 20° C.

When liquid, the liquid laundry detergent composition may be Newtonian or non-Newtonian. Preferably, the liquid laundry detergent composition is non-Newtonian. Without wishing to be bound by theory, a non-Newtonian liquid has properties that differ from those of a Newtonian liquid, more specifically, the viscosity of non-Newtonian liquids is dependent on shear rate, while a Newtonian liquid has a constant viscosity independent of the applied shear rate. The decreased viscosity upon shear application for non-Newtonian liquids is thought to further facilitate liquid detergent dissolution. The liquid laundry detergent composition described herein can have any suitable viscosity depending on factors such as formulated ingredients and purpose of the composition.

### Process of Making

Those skilled in the art will be aware of standard techniques to make the laundry detergent composition and the water-soluble unit dose article according to the present invention. Those skilled in the art will also be aware of standard techniques and methods to make the ingredients of the laundry detergent composition of the present invention.

### Process of Use

A further aspect of the present invention is a process of laundering fabrics comprising the steps of diluting between 200 and 3000 fold, preferably between 300 and 2000 fold, the water-soluble unit dose article according to the present invention with water to make a wash liquor, contacting fabrics to be treated with the wash liquor.

Preferably the wash liquor comprises between 5 L and 75 L, preferably between 7 L and 40 L, more preferably between 10 L and 20 L of water. Alternatively, the wash liquor may comprise between 35 L and 65 L of water. Preferably, the wash liquor is at a temperature of between 5° C. and 90° C., preferably between 10° C. and 60° C., more preferably between 12° C. and 45° C., most preferably between 15° C. and 40° C. Preferably, washing the fabrics in the wash liquor takes between 5 minutes and 60 minutes, preferably between 5 minutes and 40 minutes, more preferably between 5 minutes and 30 minutes, even more preferably between 5 minutes and 20 minutes, most preferably between 6 minutes and 18 minutes to complete. Alternatively, washing the fabrics in the wash liquor may take between 30 minutes and 60 minutes. Preferably, the wash liquor comprises between 1 kg and 20 kg, preferably between 3 kg and 15 kg, most preferably between 5 and 10 kg of fabrics. The wash liquor may comprise water of any hardness preferably varying between 0 gpg to 40 gpg.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.
While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Examples

Liquid laundry detergent compositions suitable for use in water-soluble unit dose laundry detergent articles were prepared through mixing of the individual components in a batch process. The appearance and the viscosity of the compositions and the interaction of the compositions with the water-soluble film (as quantified by swelling of the film), were assessed by altering the non-soap anionic surfactant to nonionic surfactant weight ratio in the surfactant system. Comparative composition 1 represents a non-compacted positive reference formulation outside the scope of the invention. Comparative composition 2 represents a related compacted negative reference formulation at equal non-soap anionic surfactant to nonionic surfactant weight ratio as the non-compacted positive reference formulation.

From the data summarized in Table 1, it can be seen that clear compacted compositions of suitable viscosity and film swelling profile can be achieved when formulating the non-soap anionic surfactant to nonionic surfactant ratio according to the invention, both for AES as well as nil AES based surfactant formulations, despite the decreased organic solvent content.

TABLE 1
Liquid detergent compositions comprising LAS, AES and NI surfactant system

| | Comp. | Comp. | Comp. | Inventive | Inventive | Inventive |
|---|---|---|---|---|---|---|
| | Example | Example | Example | Example | Example | Example |
| As 100% active | 1 | 2 | 3 | 1 | 2 | 3 |
| Total surfactant | 41.6 | 50.0 | 50.2 | 50.6 | 50.4 | 50.7 |
| Non-soap | 9:1 | 9.2:1 | 4:1 | 1:1 | 1:2 | 1:1 |
| anionic:nonionic | | | | | | |
| surfactant ratio | | | | | | |
| Total organic | 22.6 | 10.6 | 15.3 | 13.5 | 13.8 | 13.5 |
| solvent | | | | | | |
| Water | 10.7 | 11.0 | 10.9 | 10.9 | 10.8 | 11.1 |
| Nonionic | 3.4 | 4.1 | 9.3 | 24.4 | 33.0 | 25.1 |
| surfactant 1 ¹ | | | | | | |
| Nonionic | 0.7 | 0.8 | 0.8 | 0.7 | 0.7 | 0.7 |
| surfactant 2 ² | | | | | | |
| HLAS | 24.0 | 28.8 | 24.0 | 16.8 | 10.5 | 24.8 |
| H-C1215-AE2.5S | 13.4 | 16.3 | 16.0 | 8.7 | 6.2 | 0.0 |
| Topped Coconut | 5.7 | 5.5 | 5.2 | 7.1 | 8.0 | 7.6 |
| Fatty acid | | | | | | |
| Citric acid | 1.0 | 0.9 | 1.0 | 1.0 | 0.9 | 0.9 |
| 1,2-Propanediol | 16.4 | 7.7 | 10.4 | 9.9 | 10.5 | 9.9 |
| Glycerol | 6.2 | 2.9 | 3.0 | 3.6 | 3.3 | 3.6 |
| Monoethanolamine | 8.8 | 10.7 | 8.3 | 6.1 | 5.4 | 5.5 |
| Amphiphilic graft | 2.5 | 2.5 | 2.5 | 2.5 | 2.5 | 2.5 |
| polymer³ | | | | | | |
| ethoxylated | 4.0 | 3.9 | 3.9 | 3.9 | 3.9 | 4.1 |
| polyethyleneimine⁴ | | | | | | |
| GLDA chelant | 1.0 | 0.9 | 0.9 | 0.9 | 1.0 | 0.9 |
| Sodium Bisulfite | 0.4 | 0.4 | 0.4 | 0.4 | 0.4 | 0.4 |
| Hydrogenated | 0.09 | 0.09 | 0.09 | 0.09 | 0.09 | 0.09 |
| Castor Oil | | | | | | |
| Enzyme | 0.2 | 0.2 | 0.2 | 0.2 | 0.2 | 0.2 |
| (Protease, | | | | | | |
| amylase, | | | | | | |
| mananase) | | | | | | |
| Sodium Formate | 0.1 | 0.1 | 0.1 | 0.1 | 0.1 | 0.1 |
| Brightener 49 | 0.1 | 0.1 | 0.1 | 0.1 | 0.1 | 0.1 |
| Perfume, dyes | Balance | Balance | Balance | Balance | Balance | Balance |
| and minors | to 100% | to 100% | to 100% | to 100% | to 100% | to 100% |
| Appearance | Isotropic | Opaque | Hazy | Isotropic | Isotropic | Isotropic |
| | liquid | viscous | liquid | liquid | liquid | liquid |
| | | liquid | | | | |
| Viscosity (mPa · s) | 751 | 3440 | 810 | 602 | 496 | 352 |
| (20/s, 20° C.) | | | | | | |
| % swelling | 9 | −5 | −1 | 8 | 7 | 8 |

¹ Neodol C14-15 EO7, available from the Shell Company
² Natural derived C12-14 EO9
³polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains
⁴ethoxylated polyethyleneimine having an average degree of ethoxylation of 20 per EO chain and a polyethyleneimine backbone with MW of about 600

### Test Methods

### Detergent Composition Appearance

The appearance of a detergent composition is visually assessed after storing the composition in a 30 ml glass vial overnight at 20° C. The visual assessment is conducted on a nil hydrogenated castor oil nil enzyme sample, considering hydrogenated castor oil and potentially enzyme samples render the finished product slightly translucent and as such may mask eventual product haziness appearances.

### Detergent Composition Viscosity

The viscosity measurements are carried out using a rotational rheometer e.g. TA instruments HR10. The instrument includes a 40 mm 2° cone fixture with a 52 μιη gap. The measurement is carried out using a flow procedure that contains a conditioning step, a peak hold and a continuous ramp step. The conditioning step involves the setting of the measurement temperature at 20° C., a pre-shear of 10 seconds at a shear rate of 10 s⁻¹, and an equilibration of 60 seconds at the selected temperature. The peak hold involves applying a shear rate of 0.05 s⁻¹ at 20° C. for 3 min with sampling every 10 s. The continuous ramp step is performed at a shear rate from 0.1 to 1200 s⁻¹ for 3 min at 20° C. to obtain the full flow profile. The viscosity value at a shear rate of 20 s⁻¹ is extracted and reported. The detergent composition of the invention should have a viscosity between 250 and 1000 mPa·s., preferably between 300 and 800 mPa·s. Too low viscosity (below 250 mPa·s) can give rise to splashing during the dosing in the manufacturing process. Too high viscosity (above 1000 mPa·s) can give rise to stringing during the dosing in the manufacturing process, both splashing and stringing can have a negative impact on the seal strength.

### % Film Swelling

Water-soluble PVOH film samples measuring 11 cm by 12 cm are prepared and exposed to detergent compositions according to the invention and comparative compositions. A total of 750 ml of these liquid detergent compositions, is required for each test film. The bottom of a clean inert glass recipient is covered with a thin layer of liquid and a first film to be tested iss spread on the liquid; air bubbles trapped under the film are gently pushed towards the sides. A thin layer of liquid is spread on top of the first film sample followed by addition of a second film sample. This process is repeated till 5 film samples have been piled up with in-between thin film layers accordingly. The remaining liquid is then gently poured on top of the fifth film, in such a way that the films are fully immersed into the liquid. The film should remain free of wrinkles and no air bubbles should be in contact with the film. The film in contact with the liquid is stored under closed vessel conditions for 5 days at 50° C. and 1 night at 21° C. A separate glass recipient is used for each different liquid tested. The film is then removed from the storage vessel, and the excess liquid is removed from the film. A piece of paper is put on the film which is laid on top of a bench paper, and then the film is wiped dry thoroughly with dry paper, e.g. a tissue dry and free of fibers that could stick to a polyvinyl alcohol based film surface. The weight of the film is measured pre and post immersion testing, and the relative gain weight/loss is calculated and expressed as a % change according to below formula:

% change=(end weight−starting weight/starting weight)*100. The average value of the 5 film samples per test solution is calculated and reported.

A negative film swelling value may result in a brittle film upon product ageing, while a film swelling value of more than 15% may render the overall unit dose article become floppy upon ageing and as such aesthetically unappealing. Preferably the film swelling value is between 3% and 15%, more preferably between 5% and 15%.

What is claimed is:

1. A water-soluble unit-dose detergent article comprising a water-soluble film and a detergent composition,
wherein the detergent composition comprises:
from about 50% to about 65% by weight of the composition of a non-soap surfactant system comprising anionic non-soap surfactant and nonionic surfactant;
from about 5% to about 20% by weight of the composition of organic solvent; and
from about 5% to about 25% by weight of the composition of water,
wherein the nonionic surfactant comprises alcohol ethoxylate surfactant and wherein the weight ratio of non-soap anionic surfactant to non-ionic surfactant is less than or equal to about 1.5:1.

2. The detergent article according to claim 1, wherein the anionic non-soap surfactant is selected from the group consisting of: linear alkyl benzene sulphonate, alkyl ether sulphate, alkyl sulphate and mixtures thereof.

3. The detergent article according to claim 1, wherein the nonionic surfactant is selected from the group consisting of: primary alcohol ethoxylate, secondary alcohol ethoxylate, and mixtures thereof.

4. The detergent article according to claim 1 wherein the detergent is a laundry detergent.

5. The detergent article according to claim 1, wherein the organic solvent is selected from the group consisting of: 1,2-propanediol, dipropylene glycol, tripropyleneglycol, glycerol, sorbitol, polyethylene glycol, ethoxylated glycerin or a mixture thereof.

6. The detergent article according to claim 1, wherein the weight ratio of non-soap anionic surfactant to non-ionic surfactant is between about 1:2 to about 1.5:1.

7. The detergent article according to claim 1, wherein the detergent composition further comprises a fatty acid.

8. The detergent article according to claim 1, wherein the detergent composition comprises between about 1.5% and about 20% by weight of the composition of fatty acid.

9. The detergent article according to claim 1 further comprising an enzyme selected from the group consisting of proteases, amylase, cellulase, lipases, xyloglucanases, mannanases, nucleases, and a mixture thereof.

10. The detergent article according to claim 1 further comprising a thickener.

11. The detergent article according to claim 1 further comprising a performance polymer.

12. The detergent article according to claim 1 further comprising a chelant.

13. The detergent article according to claim 1 wherein the detergent composition has a pH of from about 6 to about 10 as measured in about 10% by weight water solution at about 25° C.

14. The detergent article according to claim 1, wherein the water-soluble film comprises a polyvinyl alcohol polymer.

15. The detergent article according to claim 1 wherein the water-soluble film comprises a blend of polyvinylalcohol homopolymers or a blend of polyvinylalcohol copolymers or a blend of a polyvinylalcohol homopolymer and a polyvinylalcohol copolymer.
